(19) United States
(12) Patent Application Publication
(10) Pub. No.: US 2025/0222997 A1
(43) Pub. Date: Jul. 10, 2025

(54) VEHICLE BODY STRUCTURE FOR PRODUCING MULTIPLE MODELS

(71) Applicants: Hyundai Motor Company, Seoul (KR); Kia Corporation, Seoul (KR)

(72) Inventor: Jongduk Yu, Hwaseong-si (KR)

(21) Appl. No.: 18/966,389

(22) Filed: Dec. 3, 2024

(30) Foreign Application Priority Data
Jan. 4, 2024 (KR) 10-2024-0001464

(51) Int. Cl. B62D 63/02

(52) U.S. Cl. CPC B62D 63/025

(57) ABSTRACT

A vehicle body structure for use with multiple models includes a vehicle body including a front side part, a rear side part, and a mid-zone connecting the front side part and the rear side part and having a door mounting portion disposed therein and a mid-zone inner panel connected to the door mounting portion.

### CROSS-REFERENCE TO RELATED APPLICATIONS

This application claims the benefit of Korean Patent Application No. 10-2024-0001464, filed on Jan. 4, 2024, which application is hereby incorporated herein by reference.

### TECHNICAL FIELD

The present invention relates to a vehicle body structure.

### BACKGROUND

Recently, the vehicle industry has been introducing a new concept of future mobility vision for realizing a human-centered, dynamic future city. One of these future mobility solutions is the purpose built vehicle (PBV) as a purpose-based mobility.

An example of a PBV is an electric vehicle (EV)-based environmentally friendly mobility vehicle. These PBVs can provide users with various customized services while traveling from the starting point to the destination in an unmanned or manned autonomous driving mode.

The PBV can be configured in various forms depending on the type of customized service. For example, the PBV can be used as a hailing type vehicle that configures a cabin to transport occupants. Furthermore, the PBV can be utilized as a cab type vehicle with a cabin configured only in the front part of the upper body or as a delivery type vehicle with a cabin configured in the front part of the upper body and a cargo room configured in the rear part.

The process of completing the side complement by assembling the side outer, extension, side reinforcement, and quarter in the vehicle body assemble line is called side build.

In the case of the PBV hail type vehicle, the front part of the vehicle body (FR zone; reinforce), hail side inner panel and side sill, and the rear part of the vehicle body (RR zone; rear quarter) are joined to complete the inner structure, and then the side complement is completed by assembling it with the outer plate assemble part.

A space for mounting a door is formed between the side inner panel and the side sill between the front part of the vehicle body and the rear part of the vehicle body.

In the case of the PBV delivery type vehicle, a doorless section is created in the cargo space that is blocked by the side outer without a door. The doorless section requires a structure that supports and supplements the side outer shell with the vehicle body inner parts, and this is defined as a mid-zone.

That is, the PBV delivery type vehicle has a mid-zone for a doorless section, and the delivery structure for connecting it is reflected in the FR zone and the RR zone, and then each unit is connected to form a side complement. The PBV delivery type vehicle requires a reinforcement configuration to achieve the strength of the outer panel.

The PBV hailing vehicle and delivery vehicle have dual parts, so mold costs and jig costs are incurred twice, which can result in excessive management costs.

The information contained in this background section is intended to promote understanding of the background of embodiments of the invention and may include matters that are not conventional art already known to a person of ordinary skill in the field to which this technology belongs.

### SUMMARY

The present invention relates to a vehicle body structure. Particular embodiments relate to a vehicle body structure for producing multiple models.

Embodiments of the present disclosure provide a vehicle body structure that enables the production of multiple models by unifying the side structures of a hailing vehicle and a delivery vehicle.

A vehicle body structure for producing multiple models is provided. The vehicle body structure according to exemplary embodiments may include a vehicle body including a front side part, a rear side part, and a mid-zone connecting the front side part and the rear side part and having a door mounting portion formed therein and a mid-zone inner panel connected to the door mounting portion.

The door mounting portion may include an inner flange to which the mid-zone inner panel is connected.

The mid-zone inner panel may include a mid-zone panel flange formed on the outer side of the mid-zone inner panel and matching the inner flange.

The mid-zone inner panel may include an outer panel support portion formed to protrude outwardly from the vehicle body.

The vehicle body structure according to exemplary embodiments may further include a side reinforcement supporting the mid-zone inner panel.

The side reinforcement may connect the mid-zone inner panel with the front side part and the rear side part.

The vehicle body structure according to exemplary embodiments may further include a joint member that mounts the side reinforcement to the vehicle body.

The joint member may include a joint body surrounding the side reinforcement and a joint flange formed to connect the side reinforcement to the mid-zone inner panel, the front side part, and the rear side part.

The side reinforcement may be a tubular structure.

A rack may be attached to the side reinforcement.

An interior cover may be attached to the side reinforcement.

The shape of the mid-zone inner panel may be formed by the inner shape of the door mounting portion.

The vehicle body structure capable of producing multiple models according to embodiments may produce multiple models, such as a hailing vehicle and a delivery vehicle, by unifying the side structure of the vehicle.

A vehicle body structure capable of producing multiple models according to embodiments may reduce mold costs and jig costs for vehicle production by unifying the side structure of the vehicle and can reduce management costs.

The vehicle body structure capable of producing multiple models according to embodiments does not require additional configuration to reinforce the strength of the outer shell when applied to a delivery vehicle.

In addition, the effects that can be obtained or expected from embodiments of the present invention are directly or implicitly disclosed in the detailed description of the embodiments of the present invention. That is, various effects predicted according to embodiments of the present invention will be disclosed in the detailed description to be provided later.

### BRIEF DESCRIPTION OF THE DRAWINGS

Since these drawings are for reference in explaining exemplary embodiments of the present invention, the technical ideas of the embodiments of the present invention should not be interpreted as limited to the attached drawings.

FIG. 1 is a side view showing a vehicle body structure according to an embodiment.

FIG. 2 is partial exploded perspective view of the vehicle body structure according to an embodiment.

FIG. 3 is a side view showing a mid-zone inner panel and a mid-zone of a vehicle body structure according to an embodiment.

FIG. 4 is a partial side view showing the mid-zone inner panel and the mid-zone of the vehicle body structure according to an embodiment.

FIG. 5 is a perspective view of a side reinforcement that can be applied to the vehicle body structure according to an embodiment.

FIG. 6 is a cross-sectional view along line VI-VI of FIG. 3.

FIG. 7 is a cross-sectional view along line VII-VII of FIG. 3.

FIG. 8 is a drawing showing a mounting of a rack that can be applied to the vehicle body structure according to an embodiment.

The following reference identifiers may be used in connection with the drawings to describe various features of embodiments of the present invention.

10: vehicle body
20: vehicle body side part
22: front side part
24: rear side part
26: mid-zone
28: door mounting portion
30: inner flange
40: mid-zone inner panel
42: outer panel support portion
44: mid-zone outer panel
48: mid-zone panel flange
50: side reinforcement
60, 62: joint member
64, 65: joint body
68, 69: joint flange
70: rack
80: interior cover
90: outer panel

It should be understood that the drawings referenced above are not necessarily drawn to scale, but rather present rather simplified representations of various preferred features illustrating the basic principles of embodiments of the present invention.

For example, specific design features of embodiments of the present invention, including particular dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that a person having ordinary skill in the art to which the present invention pertains can easily implement the present invention.

As those skilled in the art would realize, the described embodiments may be modified in various different ways, all without departing from the spirit or scope of the present invention.

In order to clearly explain the embodiments of the present invention, parts irrelevant to the description are omitted, and the same reference numerals are used for identical or similar components throughout the specification.

The size and thickness of each component shown in the drawings are arbitrarily shown for convenience of explanation, and the embodiments of the present invention are not necessarily limited to what is shown in the drawings. In order to clearly express various parts and areas, the thickness is shown by enlarging it.

In addition, in the detailed description below, the names of the components are divided into first, second, etc. to distinguish them when the components are in a similar relationship, and the description below is not necessarily limited to that order.

Throughout the specification, whenever a part is said to include a certain component, this does not mean that it excludes other components, but rather that it may include other components, unless otherwise specifically stated.

Additionally, terms such as part, portion, means, etc. described in the specification mean comprehensive units of composition that perform at least one function or operation.

When we say that a part, such as a layer, membrane, region, or plate, is “over” another part, this includes not only cases where it is directly over the other part, but also cases where there are other parts in between.

In contrast, when an element is referred to as being “directly on” another element, there are no intervening elements present.

In this specification, the term ‘connected’ indicates a physical relationship between two components in which the components are directly connected to each other by welding, rivets, self piercing rivet (SPR), flow drill screw (FDS), structural adhesive, etc., or indirectly connected through one or more intermediate components.

As used herein, ‘vehicle’, ‘vehicular’, ‘automotive’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs, hydrogen-powered vehicles and other alternative fuel vehicles (e.g., other than petroleum fuel derived from resources).

In this specification, the ‘front-to-back direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

Furthermore, in this specification, ‘upper end’, ‘upper portion’, or ‘upper surface’ of a component indicates an end, portion, or surface of a component that is relatively upper in the drawing, and ‘lower end’, ‘lower portion’, or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

An embodiment will hereinafter be described in detail with reference to the accompanying drawings.

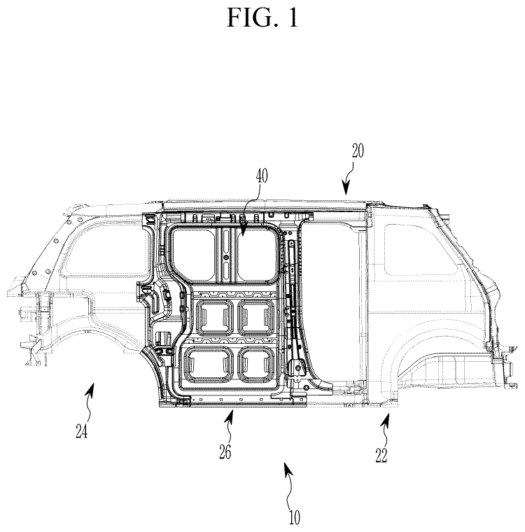

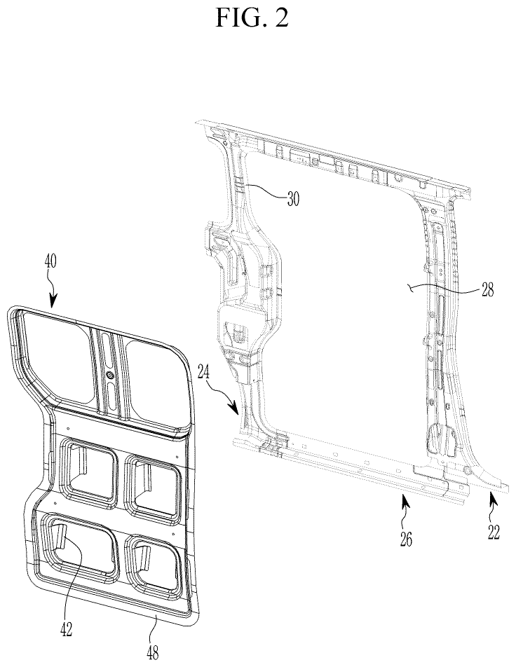

FIG. 1 is a side view showing a vehicle body structure according to an embodiment, and FIG. 2 is partial exploded perspective view of the vehicle body structure according to an embodiment.

Referring to FIG. 1 and FIG. 2, a vehicle body structure capable of producing multiple models according to an embodiment can be applied to a vehicle body side part 20 of a vehicle body 10.

The vehicle body 10 may include a front side part 22, a rear side part 24, and a mid-zone 26 connecting the front side part 22 and the rear side part 24.

The front side part 22 is a configuration that forms the front of the vehicle body 10, and may be configured to include, for example, a front door, a front window, etc.

The rear side part 24 is a configuration forming the rear of the vehicle body 10 and may include, for example, a rear quarter.

The mid-zone 26 may be provided with a door mounting portion 28 on which a door is mounted for boarding and disembarking occupants.

That is, the vehicle body 10 may be a vehicle body applied to a hailing vehicle transporting an occupant.

To produce the delivery type PBV and the hailing type PBV, separate molds and jigs are required, which increases the cost of double production and may result in excessive management costs.

Therefore, if the vehicle bodies of the delivery type PBV and the hailing type PBV are produced in common, the production cost can be reduced and productivity can be improved.

The vehicle body structure capable of producing multiple models according to an embodiment may include a mid-zone inner panel 40 connected to the door mounting portion 28.

That is, the vehicle body structure capable of producing multiple models according to an embodiment can produce a delivery type PBV by connecting the mid-zone inner panel 40 to the vehicle body 10 used for producing a hailing vehicle.

The door mounting portion 28 may be formed with an inner flange 30 to which the mid-zone inner panel 40 is connected.

The inner flange 30 may be used in a configuration that is in close contact with a door (not shown) of a hailing vehicle, or it may be used in a configuration that junctions the mid-zone inner panel 40 of a delivery vehicle.

The mid-zone inner panel 40 may include a mid-zone panel flange 48 formed on an outer side of the mid-zone inner panel 40 and matching the inner flange 30.

The shape of the mid-zone inner panel 40 may be formed into the inner shape of the door mounting portion 28.

That is, the mid-zone panel flange 48 is formed in a shape identical to or similar to the inner flange 30 and may be closely connected to the inner flange 30.

This allows the mid-zone inner panel 40 to be stably connected to the door mounting portion 28.

The mid-zone inner panel 40 may have a mounting function for the interior cover and may act as a strength member of the outer panel without separate additional configuration. In addition, the mid-zone inner panel 40 may be attached to a body for producing a vehicle with a door to implement a doorless body according to an assembly-type structural concept

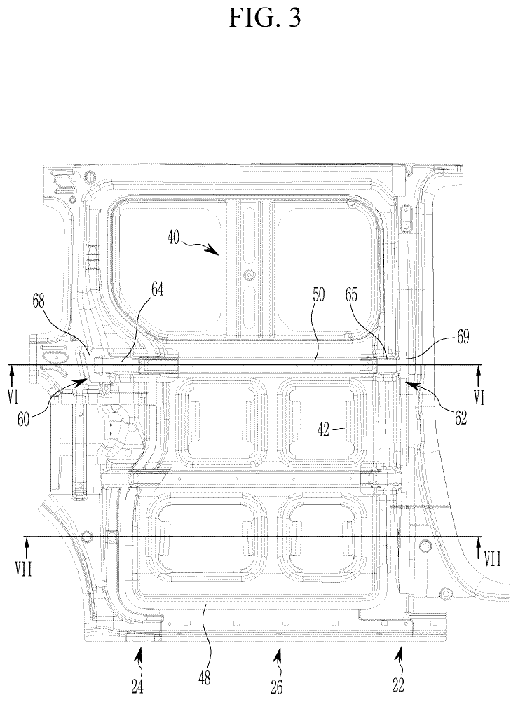

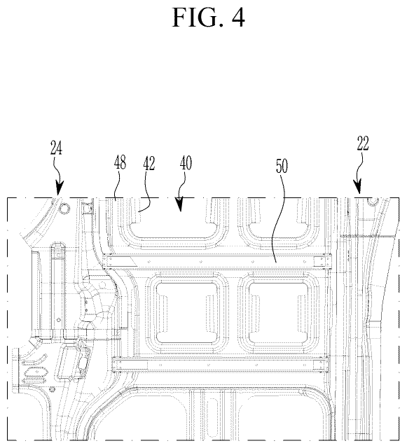

FIG. 3 is a side view showing a mid-zone inner panel and a mid-zone of a vehicle body structure according to an embodiment, and FIG. 4 is a partial side view showing the mid-zone inner panel and the mid-zone of the vehicle body structure according to an embodiment.

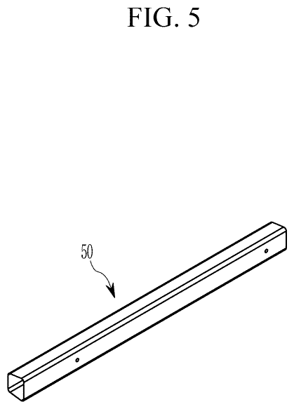

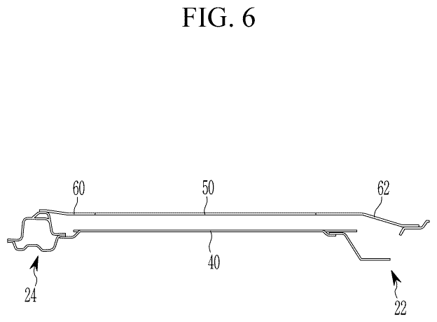

FIG. 5 is a perspective view of a side reinforcement that can be applied to the vehicle body structure according to an embodiment, and FIG. 6 is a cross-sectional view along line VI-VI of FIG. 3.

Referring to FIG. 1 to FIG. 6, the vehicle body structure capable of producing multiple models according to an embodiment may further include a side reinforcement 50 supporting the mid-zone inner panel 40.

The side reinforcement 50 may connect the mid-zone inner panel 40, the front side part 22, and the rear side part 24.

The side reinforcement 50 may support the mid-zone inner panel 40 and act as a kind of impact beam to absorb impact load in the event of a vehicle collision.

Additionally, the side reinforcement 50 may increase the overall strength of the vehicle body by connecting the front side part 22 and the rear side part 24.

The side reinforcement 50 may be a tubular structure.

The side reinforcement 50 may support the strength of the vehicle body 10 with a simple shape and may be applied to vehicle bodies of various specifications by changing the length.

The drawing shows two side reinforcements 50 mounted in parallel, but this is not a limitation, and one or three or more side reinforcements may be mounted depending on the consumer's demand condition or vehicle body strength condition.

The vehicle body structure capable of producing multiple models according to an embodiment may further include joint members 60 and 62 that mount the side reinforcement 50 to the vehicle body 10.

The joint members 60 and 62 may include joint bodies 64 and 65 surrounding the side reinforcement 50 and joint flanges 68 and 69 formed to connect the side reinforcement 50 to the mid-zone inner panel 40, the front side part 22, and the rear side part 24.

The joint members 60 and 62 can stably connect the side reinforcement 50 to the mid-zone inner panel 40, and furthermore, the joint members 60 and 62 are connected to the mid-zone inner panel 40, the front side part 22, and the rear side part 24, thereby improving the joint strength of the mid-zone inner panel 40 with the front side part 22 and the rear side part 24.

The vehicle body structure, which can be produced in multiple models according to an embodiment, does not require the addition of a separate component to the front side part 22 and the rear side part 24 to block the mid-zone of the PBV doorless section.

That is, the vehicle body structure capable of producing multiple models according to an embodiment enables the production of a PBV without doors without additional configuration changes to the front side part and rear side part of a PBV with doors.

Therefore, the vehicle body structure capable of producing multiple models according to an embodiment can simplify the structure, prevent dualization of specifications for production, and provide an assembled doorless structure without changing the front side part and the rear side part.

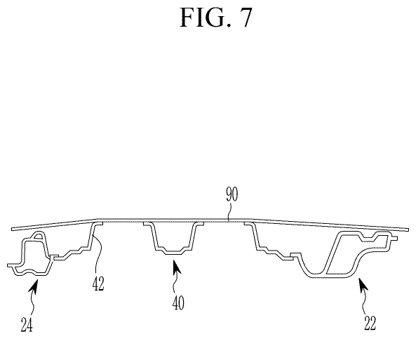

FIG. 7 is a cross-sectional view along line VII-VII of FIG. 3.

Referring to FIG. 4 and FIG. 7, the mid-zone inner panel 40 may include an outer panel support portion 42 formed to protrude outwardly of the vehicle body 10.

The vehicle body structure capable of producing multiple models according to an embodiment may further include an outer panel 90 forming the appearance of the vehicle body 10, and the outer panel support portion 42 may support the outer panel 90.

For example, the outer panel support portion 42 and the outer panel 90 can be joined by welding to stably support the outer panel 90.

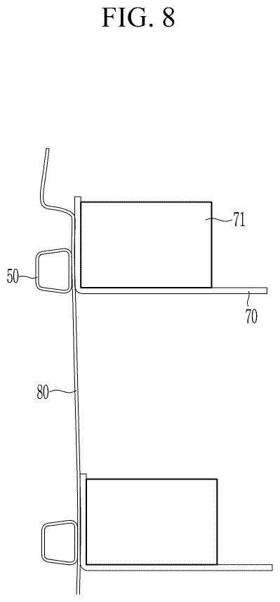

FIG. 8 is a drawing showing a mounting of a rack that can be applied to the vehicle body structure according to an embodiment.

Referring to FIG. 8, a rack 70 may be connected to the side reinforcement 50.

For delivery vehicles, a rack to support the cargo 71 may be required, and a separate configuration may be required to mount the rack stably.

However, the vehicle body structure according to an embodiment can mount the rack 70 using the side reinforcement 50 without a separate additional configuration, thereby simplifying the configuration and improving marketability.

For example, the rack 70 can be connected to the side reinforcement 50 using bolts.

The drawing shows two racks 70 mounted, but the embodiments are not limited to two, and various numbers and sizes of racks can be mounted depending on the number of side reinforcements 50, consumer requirements, etc.

An interior cover 80 can be combined with the side reinforcement 50.

By mounting the interior cover 80 on the side reinforcement 50, which is a rigid member, the space utilization of the cargo room can be increased and stable mounting is possible.

According to the vehicle body structure according to an embodiment, the protruding portion for loading goods in the cargo room space of a delivery vehicle can be reduced to increase space utilization.

In addition, according to the vehicle body structure according to an embodiment, the rack for loading objects can be installed on the side reinforcement without adding a separate configuration according to consumer needs, etc., thereby improving marketability.

In addition, according to the vehicle body structure according to an embodiment, it is possible to improve productivity and reduce production costs by unifying the side structures of the hailing vehicle and the delivery vehicle.

While embodiments of this invention have been described in connection with what is presently considered to be practical embodiments, it is to be understood that the embodiments are not limited to the disclosed embodiments. On the contrary, they are intended to cover various modifications and equivalent arrangements included within the spirit and scope of the appended claims.

What is claimed is:

1. A vehicle body structure for use with multiple models, the vehicle body structure comprising:
a vehicle body comprising a front side part, a rear side part, and a mid-zone connecting the front side part and the rear side part and having a door mounting portion disposed therein; and
a mid-zone inner panel connected to the door mounting portion.

2. The vehicle body structure of claim 1, wherein the door mounting portion comprises an inner flange to which the mid-zone inner panel is connected.

3. The vehicle body structure of claim 2, wherein the mid-zone inner panel comprises a mid-zone panel flange disposed on an outer side of the mid-zone inner panel and matching the inner flange.

4. The vehicle body structure of claim 1, wherein the mid-zone inner panel comprises an outer panel support portion that protrudes outwardly from the vehicle body.

5. The vehicle body structure of claim 1, further comprising a side reinforcement configured to support the mid-zone inner panel.

6. The vehicle body structure of claim 5, wherein the side reinforcement connects the mid-zone inner panel with the front side part and the rear side part.

7. The vehicle body structure of claim 6, further comprising a joint member, wherein the side reinforcement is mounted to the vehicle body by the joint member.

8. The vehicle body structure of claim 7, wherein the joint member comprises:
a joint body surrounding the side reinforcement; and
a joint flange connecting the side reinforcement to the mid-zone inner panel, the front side part, and the rear side part.

9. The vehicle body structure of claim 5, wherein the side reinforcement is a tubular structure.

10. The vehicle body structure of claim 5, further comprising a rack coupled to the side reinforcement.

11. The vehicle body structure of claim 5, further comprising an interior cover coupled to the side reinforcement.

12. The vehicle body structure of claim 1, wherein a shape of the mid-zone inner panel matches an inner shape of the door mounting portion.

13. A vehicle comprising:
a vehicle body comprising a vehicle body side part, the vehicle body side part comprising:
a front side part;
a mid-zone coupled to a rear portion of the front side part; and
a rear side part coupled to a rear portion of the mid-zone, wherein the front side part, the mid-zone, and the rear side part extend in a longitudinal direction of the vehicle body;
a door mounting portion disposed in the mid-zone and comprising an inner flange; and
a mid-zone inner panel coupled to the inner flange.

14. The vehicle of claim 13, wherein the vehicle is a delivery type vehicle.

15. The vehicle of claim 13, wherein the vehicle is a hailing type vehicle.

16. The vehicle of claim 13, wherein the mid-zone inner panel comprises a mid-zone panel flange disposed on an outer side of the mid-zone inner panel and matching the inner flange.

17. The vehicle of claim 13, wherein a shape of the mid-zone inner panel matches an inner shape of the door mounting portion.

18. The vehicle of claim 13, further comprising a side reinforcement connecting the mid-zone inner panel, the front side part, and the rear side part.

19. The vehicle of claim 18, further comprising:
a rack coupled to the side reinforcement; and
an interior cover coupled to the side reinforcement.

20. A method of making a plurality of vehicles, the method comprising:
assembling a first vehicle that comprises a first vehicle body having a front side part, a rear side part, and a mid-zone connecting the front side part and the rear side part and having a door mounting portion disposed therein, the first vehicle body also comprising a mid-zone inner panel connected to the door mounting portion; and
assembling a second vehicle that comprises a second vehicle body having a front side part, a rear side part, and a mid-zone connecting the front side part and the rear side part and having a door mounting portion disposed therein, the second vehicle body also comprising a mid-zone inner panel connected to the door mounting portion;
wherein the first vehicle is a first model and the second vehicle is a second model that is different than the first model.
